(19) United States
(12) Patent Application Publication
(10) Pub. No.: US 2017/0038337 A1
(43) Pub. Date: Feb. 9, 2017

(54) SAMPLE SEPARATION/TRANSFER DEVICE AND SAMPLE ANALYSIS METHOD

(71) Applicant: SHARP KABUSHIKI KAISHA, Sakai City, Osaka (JP)

(72) Inventors: Shinichi GOTO, Sakai City (JP); Hideki KINOSHITA, Sakai City (JP)

(21) Appl. No.: 15/303,554

(22) PCT Filed: Dec. 8, 2015
(86) PCT No.: PCT/JP2015/084342

§ 371 Date: Oct. 12, 2016

(30) Foreign Application Priority Data
Apr. 10, 2015 (JP) 2015-081265

(51) Int. Cl. G01N 27/447; G01N 1/31; G01N 1/30

(52) U.S. Cl. CPC G01N 27/44739; G01N 27/44708; G01N 27/44747; G01N 1/30; G01N 1/31

(57) ABSTRACT

A novel technique is provided for automatically performing the separation and transfer of analyte, and subsequent processing. A sample separation/transfer device (100) is a device for separating analyte by way of electrophoresis, dispensing the separated analyte from a dispensing part (50a) inside a buffer tank (30), and transferring the separated analyte to a transfer membrane (1) by way of causing the transfer membrane (1) to abut the dispensing part (50a) and move, in which the device includes a liquid delivery pump (11a, 11b) that replaces the liquid filling the buffer tank (30).

### TECHNICAL FIELD

The present invention relates to electrophoresis, and in particular, relates to a sample separation/transfer device that separates analyte by way of electrophoresis, transfers the separated analyte to a transfer membrane, and then performs subsequent processing.

### BACKGROUND ART

After the completion of the human genome project until the present day, the relationship between various diseases and biopolymers has been being clarified. In particular, proteins, which are one type of biopolymer directly, impart the functions of the cells, organs and internal organs of living organisms, and the possibility of causing many diseases due to the differences in amino acid sequence and stereostructure, the sugar chain, and chemical modifications such as phosphorylation, etc. is starting to become clear.

In such a situation, an abundance of proteome analysis is being performed. Proteome indicates an entire set of proteins that are translated and produced in specific cells, organs and internal organs, and as analysis thereof, the profiling, functional analysis, etc. of proteins can be exemplified. Thereamong, the proteins synthesized in living bodies after translation of proteins have been known to perform the control of functions of the proteins by posttranslational modification such as phosphorylation, and the acquisition of information related to the chemical modification of proteins can be one of the important matters in future proteome analysis. For this reason, methods of separating and analyzing samples in which a plurality of proteins coexist with high precision are given emphasis, and the development of devices for this purpose is being promoted.

Currently, as separation techniques for beneficial proteins, there is gel electrophoresis, capillary electrophoresis, liquid chromatography, etc.; however, gel electrophoresis is widely employed in general due to the level of ease and separability thereof.

Currently, in the detection of chemical modifications of proteins, a technique of performing Western blotting after electrophoresis is mainly adopted. Samples of proteins separated by way of electrophoresis are fixated by causing to adsorb to a transfer membrane by a technique called transfer (blotting). Subsequently, when the proteins adsorbed to the transfer membrane are overlaid with a specific antibody or probe with fluorescence labeling or radioactive marking, it becomes possible to detect specific proteins based on the antigen-antibody reaction. This flow sequence is referred to as Western blotting. A nitrocellulose membrane, PVDF (polyvinylidene difluoride) membrane, or the like to which the sample easily bonds and has high hydrophobicity is used as the transfer membrane.

A combination of electrophoresis and Western blotting in this way is a very effective method in proteome analysis (for example, refer to Non-patent Document 1).

Conventionally, electrophoresis and Western blotting are each performed by way of the manual labor of a researcher using independent devices. For example, after performing isoelectric point electrophoresis and SDS-PAGE with an electrophoresis device, it is common for the gel to be removed from the device and moved to a transfer device, the transfer membrane to be set and transfer (blotting) performed, and then overlaid manually with antibody or probe on the transfer membrane. Since the gel used in this operation is a very soft material and difficult to handle, manipulation is complex, and requires proficiency in this work. Therefore, technology automating this work is being developed. For example, Patent Documents 1 and 2 disclose devices that automate a series of operations from electrophoresis to blotting. In addition, Patent Document 3 discloses a gel cassette for simultaneously performing phoresis and transfer. Furthermore, Patent Document 4 discloses a device that automatically processes a transcriptional body to which a living body sample has been transferred.

Patent Document 1: U.S. Pat. No. 5,234,559 (registered Aug. 10, 1993)

Patent Document 2: Japanese Published Unexamined Patent Application “Japanese Unexamined Patent Application, Publication No. 2011-808042 (published Apr. 21, 2011)”

Patent Document 3: Japanese Published Translation of PCT International Publication for Patent Applications “Japanese Unexamined Patent Application (Translation of PCT Publication), Publication No. H9-501774 (published Feb. 18, 1997)”

Patent Document 4: Japanese Published Unexamined Patent Application “Japanese Unexamined Patent Application, Publication No. 2011-58968 (published Mar. 24, 2011)”

Non-Patent Document 1: Notebook for Protein Experiments (basic): From Separation Identification to Function Analysis (Yodosha Co., Ltd., 2005, pp. 38-47)

### DISCLOSURE OF THE INVENTION

### Problems to be Solved by the Invention

However, the aforementioned such conventional technology has problems in that it is not possible to automatically perform the separation and transfer of analyte, or subsequent processing.

The present invention has been made taking account of the above-mentioned issues, and has a main object of providing novel technology for automatically performing the separation and transfer of analyte, and subsequent processing.

### Means for Solving the Problems

In order to solve the above-mentioned problems, a sample separation/transfer device according to an aspect of the present invention separates analyte by way of electrophoresis, dispenses the analyte thus separated from a dispensing part in a buffer tank, and transfers the analyte thus separated onto a transfer membrane by causing the transfer membrane to abut the dispensing part and move, the sample separation/transfer device including a liquid delivery pump that replaces liquid filling the buffer tank.

### Effects of the Invention

According to the first aspect of the present invention, it is possible to automatically perform the separation and transfer of analyte and subsequent processing, and thus exert the effect of streamlining Western blotting.

### BRIEF DESCRIPTION OF THE DRAWINGS

FIG. 1 is a perspective view showing an outline configuration of a sample separation-transfer device according to a first embodiment of the present invention;

FIG. 2 is a cross-sectional view showing an outline configuration of a sample separation-transfer device according to the first embodiment of the present invention;

FIG. 3 is a perspective view showing the position of a nozzle in the first embodiment of the present invention;

FIG. 4 provides schematic drawings illustrating functions of a partition panel in the first embodiment of the present invention;

FIG. 5 is a perspective view showing the position of a nozzle in a second embodiment of the present invention;

FIG. 6 is a top view showing the positions of hydrophilic and hydrophobic regions of a bottom face of an anode buffer tank in a third embodiment of the present invention;

FIG. 7 provides top views showing grooves provided in the bottom face of the anode buffer tank in modified examples of the second and third embodiment of the present invention;

FIG. 8 provides schematic drawings illustrating functions of a lift plate in a fourth embodiment of the present invention; and

FIG. 9 is a perspective view showing an outline configuration of a sample separation/transfer device according to a fifth embodiment of the present invention.

### PREFERRED MODE FOR CARRYING OUT THE INVENTION

### First Embodiment

An embodiment (first embodiment) of the present invention is as follows when explaining based on the drawings.

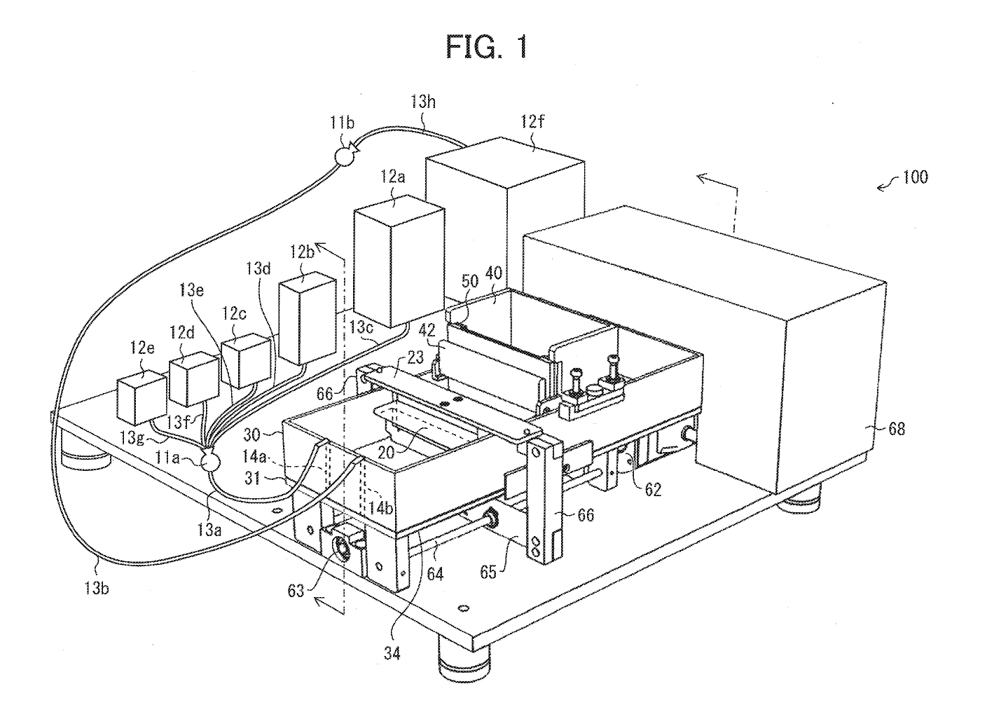

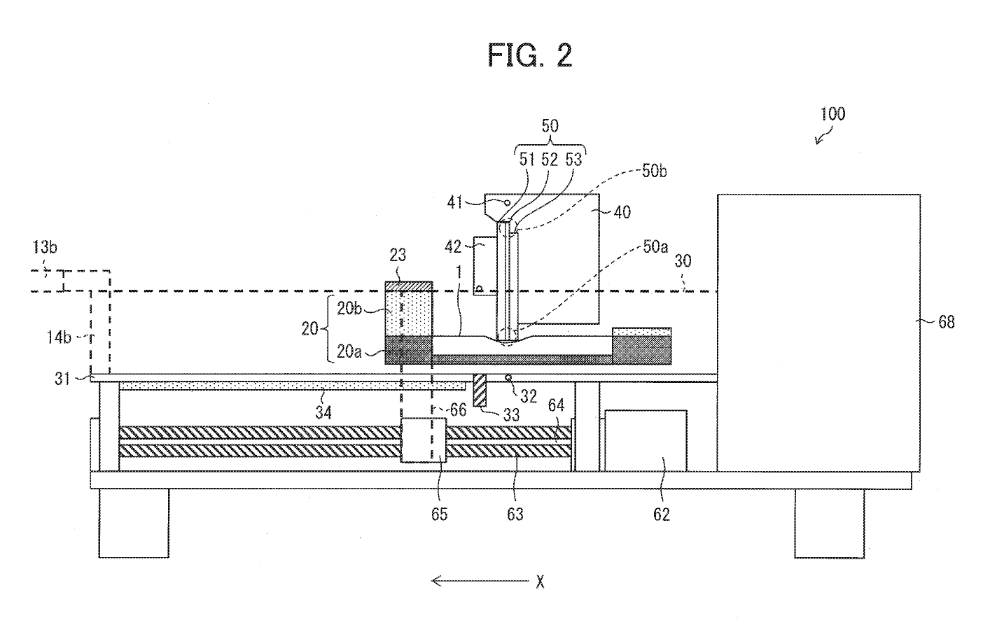

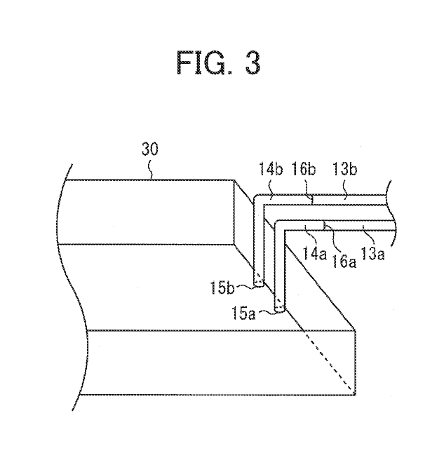

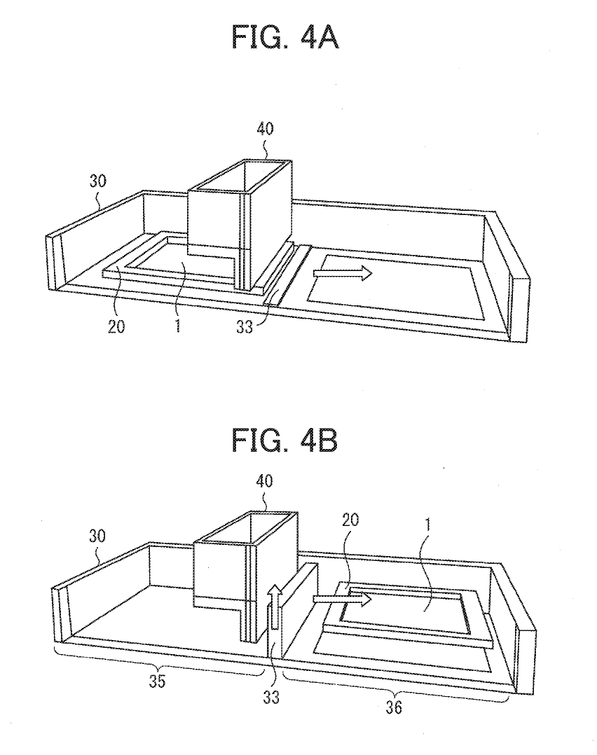

First, a schematic configuration of a sample separation/transfer device 100 according to the first embodiment will be explained by referencing FIGS. 1 to 4. FIG. 1 is a perspective view schematically showing a configuration of the sample separation/transfer device 100. FIG. 2 is a cross-sectional view schematically showing the configuration of the sample separation/transfer device 100. FIG. 3 is a perspective view showing the position of a nozzle in the sample separation/transfer device 100. FIG. 4 provides schematic drawings illustrating the functions of a lift plate of the sample separation/transfer device 100.

As shown in FIGS. 1 and 2, the sample separation/transfer device 100 is a sample separation/transfer device that separates an analyte by way of electrophoresis, dispenses the separated analyte from a dispensing part, and after transferring the separated analyte to a transfer membrane by causing the transfer membrane to abut with the dispensing part and causing to move, replaces the solution in the anode buffer tank using a pump, and performs subsequent processing, i.e. washing, blocking, antibody reaction and detection reaction (staining, luminescence, or the like), and includes pumps (liquid delivery pump) 11a, 11b, tanks 12a to 12f, tubes 13a to 13h, nozzles 14a, 14b, a frame 20, a carrier (arm part) 23, an anode buffer tank (buffer solution tank) 30, a table 31, a Peltier element 34, a cathode buffer tank 40, a separation unit 50, a motor (drive unit) 62, a ball screw (drive unit) 63, a guide shaft (drive unit) 64, a shaft holder (drive unit) 65, guide poles (arm part) 66, and a control unit 68. In addition, although not illustrated for explanation, a lid covering the entirety during operation is further included for safety.

Herein, the separation unit 50 accommodates separation gel (separation medium) 52, and has a first opening (dispensing part) 50a that opens within the anode buffer tank 30 and a second opening 50b that opens within the cathode buffer tank 40. In addition, a transfer membrane 1 is arranged inside of the anode buffer tank 30 so as to face the first opening 50a. Furthermore, an anode 32 is arranged within the anode buffer tank 30, and a cathode 41 is arranged within the cathode buffer tank 40.

For this reason, with the sample separation/transfer device 100, the cathode 41 within the cathode buffer tank 40 and the anode 32 within the anode buffer tank 30 are electrically connected via the buffer solutions of the two tanks, separation gel 52 and transfer membrane 1, by filling buffer solutions into the cathode buffer tank 40 and anode buffer tank 30. In other words, by applying a voltage between the cathode 41 and anode 32, the sample separation/transfer device 100 is a device that separates a sample introduced from the second opening 50b by way of the separation gel 52 and causes each separated component to be dispensed from the first opening 50a and adsorb to the transfer membrane 1.

Hereinafter, the respective principle members will be explained in detail by referencing FIGS. 1 to 4.

(Anode and Cathode)

The anode 32 is arranged within the anode buffer tank 30, and the cathode 41 is arranged within the cathode buffer tank 40. The anode 32 and cathode 41 are formed from a material having electrical conductivity such as a metal. As the material forming the anode 32 and cathode 41, for example, platinum is preferred from the viewpoint of suppressing ionization of the electrodes.

The electrode arrangements of these are not particularly limited so long as the anode 32 is arranged within the anode buffer tank 30 and the cathode 41 is arranged within the cathode buffer tank 40 so as to be immersed in cathode buffer; however, for example, the cathode 41, first opening 50a and anode 32 may be arranged on substantially the same straight line. In such an arrangement, so long as the transfer membrane 1 is arranged as shown in FIG. 1, the precision of sample adsorption can be improved since the line of electric force passing through the first opening 50a will be substantially vertical relative to the transfer membrane 1.

In addition, the anode 32 is preferably arranged to be distanced from the transfer membrane 1. It is thereby possible to suppress the bubbles generating from the anode 32 from negatively influencing the adsorption of separated components on the transfer membrane 1.

The anode 32 and cathode 41, for example, may be used by connecting to the control unit 68, or may be used by connecting to an external power supply (DC power source). In the case of using by connecting to an external power supply, after setting the time, current and voltage in the power supply, the control unit 68 may be operated to cause the sample separation/transfer device 100 to start operation at the same time as operation initiation of the power supply.

(Anode Buffer Tank and Cathode Buffer Tank)

The anode buffer tank 30 and cathode buffer tank 40 are insulative containers storing the buffer solution (buffer). The cathode buffer tank 40 is provided above the anode buffer tank 30. It should be noted that, in the first embodiment, the anode buffer tank 30 is fixed on the table 31, and the cathode buffer tank 40 is fixed to the anode buffer tank 30; however, the present invention is not limited to this configuration.

The buffer solutions filled in the anode buffer tank 30 and cathode buffer tank 40 can be any buffer solution having electrical conductivity, and particularly, a buffer solution having a buffering region of weakly acidic to weakly basic can be suitably used. As such a buffer solution, for example, it is possible to use buffer solutions such as a Tris/glycine-based buffer solution, acetic acid buffer solution, sodium carbonate-based buffer solution, CAPS buffer solution, Tris/boric acid/EDTA buffer solution, Tris/acetic acid/EDTA buffer solution, MOPS, phosphoric acid buffer solution, and Tris/tricine-based buffer solution.

The anode buffer tank 30 accommodates the partition panel 33 at the bottom face. The partition panel 33 is mobile in the vertical direction relative to the bottom face of the anode buffer tank 30. As shown in FIG. 4, by the partition panel 33 projecting within the anode buffer tank 30 from the bottom face of the anode buffer tank 30, the anode buffer tank 30 is divided into two regions (first region 35 and second region 36). The first region 35 is a space on the side on which the cathode buffer tank 40 is equipped. The second region 36 is a space on the side on which the cathode buffer tank 40 is not equipped. The partition panel 33 is watertight, and thus the liquid poured into the second region 36 will not leak into the first region 35. The second region 36 is sufficiently large for the frame 20 to fit. According to such a configuration, since the processing steps after transfer can be performed only in the second region 36, it is possible to advance reaction efficiently with the minimum liquid volume for the processing steps after transfer. It should be noted that the first region 35 refers to a region for performing electrophoresis and transfer, and the second region 36 refers to a region for post-transfer performing processing.

Inside the anode buffer tank 30, nozzles 14a, 14b are provided at an inside face of the second region 36. An end (opening part 15a) of the nozzle 14a faces the bottom face of the anode buffer tank 30 to be separated by about 5 mm to 50 mm. The nozzle 14a extends outside of the anode buffer tank 30, and the other end (connection 16a) of the nozzle 14a connects with a tube 13a outside of the anode buffer tank 30. In addition, an end (opening part 15b) of the nozzle 14b faces the bottom face of the anode buffer tank 30 to be separated by about 5 mm to 50 mm. The nozzle 14b extends outside of the anode buffer tank 30, and the other end (connection 16b) of the nozzle 14b connects with a tube 13b outside of the anode buffer tank 30.

According to such a configuration, it is possible to establish one of the nozzles 14a, 14b for dispensing, and the other for injecting. For this reason, it is possible to easily replace the liquid filling the anode buffer tank 30.

In addition, the nozzles 14a, 14b are provided at the inside face at an end of the anode buffer tank 30 in the movement direction of the transfer membrane 1 during transfer. In addition, the nozzles 14a, 14b extend in the movement direction to outside of the anode buffer tank 30. For this reason, it is possible to successfully perform the respective steps without becoming obstacles to the movement of the transfer membrane 1. It should be noted that the positions of the nozzles 14a, 14b are not limited thereto, and may be other positions so long as being positions that do not become obstacles to the movement of the transfer membrane 1.

The nozzles 14a, 14b are preferably configured by insulating material, e.g., plastic. So long as using such material, it will be possible to successfully perform electrophoresis, without inhibiting the flow of the line of electric force in the vicinity of the anode.

The anode buffer tank 30 includes the Peltier element 34 at an outer bottom face of the second region 36. By including the Peltier element 34, it is possible to adjust the temperature of the liquid inside the anode buffer tank 30 in each step to a suitable temperature for the step.

(Separation Unit)

The separation unit 50 accommodates the separation gel 52 at the interior thereof. In the first embodiment, the separation unit 50 is standing in a substantially vertical direction, and the lower part thereof is arranged within the anode buffer tank 30, and the upper part thereof is arranged so that one side contacts the cathode buffer tank 40. The separation gel 52 is thereby liquid-cooled by at least one of the buffer solution within the anode buffer tank 30 and the buffer solution within the cathode buffer tank 40, and thus can be sufficiently cooled.

In addition, the separation unit 50 has the first opening 50a that opens within the anode buffer tank 30, and the second opening 50b that opens within the cathode buffer tank 40. It is thereby configured so that the separation gel 52 faces inside the anode buffer tank 30 via the first opening 50a, and faces inside the cathode buffer tank 40 via the second opening 50b. It should be noted that, in the first embodiment, the separation unit 50 is fixed to the cathode buffer tank 40 by the lock 42 provided to the cathode buffer tank 40; however, the present invention is not limited to this configuration.

The separation unit 50 can be configured from two insulating plates 51, 53 formed from insulators such as glass or acrylic. In one embodiment, the separation unit 50 exposes the separation gel 52 by a part of the insulating plate 53 being notched out at the second opening 50b, whereby sample can be easily introduced to the separation gel 52.

The separation gel 52 is a gel for separating the sample components introduced from the second opening 50b according to the molecular weight. The separation gel 52 can be filled into the separation unit 50 prior to installation of the separation unit 50 to the sample separation/transfer device 100, or after installing. In addition, a commercially available PAGE chip into which the separation gel 52 is filled may be used as the separation unit 50. As an example of the separation gel 52, acrylamide gel, agarose gel and the like are exemplified. The width of the separation gel 52 can be established as a length enabling a 10- to 12-lane sample to be separated, for example. It should be noted that the separation medium in the present invention is not limited to gel, and may be another medium that can perform the separation of analyte.

It should be noted that, although a configuration filling the separation gel 52 into the separation unit 50 is being adopted in the first embodiment, a configuration providing a large number of ultrafine posts called nano-pillars between the insulating plate 51 and insulating plate 53 can also be adopted.

It addition, the first opening 50a of the separation unit 50 may be covered by a coating part formed by an electrically conductive porous material (e.g., hydrophilic PVDF membrane, hydrophilic PTFE (polytetrafluoroethylene) membrane, etc.), including the circumference thereof. In the case of the transfer membrane 1 contacting or being pushed against the first opening 50a (case of not providing a distance between the first opening 50a and transfer membrane 1), the transfer membrane 1 can reduce the frictional resistance and damage incurred from the separation unit 50 and separation gel 52 when the transfer membrane 1 is conveyed.

It should be noted that, by the separation unit 50 standing in a substantially vertical direction, the separation unit 50 can greatly increase the sample introduction amount compared to a configuration being installed in a substantially horizontal direction. This is because, with the horizontal-type sample separation/transfer device, it is difficult to change the depth of the well provided in the separation gel; however, with the vertical-type sample separation/transfer device, since the depth of the well can be changed easily, the sample introduction amount can be made to increase easily.

(Transfer Membrane 1)

It is preferable for the transfer membrane 1 to be an absorbing/retaining body of samples that enables to stably preserve a sample separated by the separation gel 52 over a long period, and further, facilitates subsequent analysis. As the material of the transfer membrane 1, it is preferably a material having high strength, and having high sample binding capacity (adsorbable weight per unit volume). As the transfer membrane 1, a PVDF membrane or the like is suited in the case of the sample being protein. It should be noted that it is preferable to perform hydrophilization treatment using methanol or the like in advance on the PVDF membrane. Otherwise, a membrane conventionally used in the adsorption of proteins, DNA and nucleic acids such as a nitrocellulose membrane or nylon membrane can also be used.

It should be noted that, the samples that can be separated and adsorbed in the sample separation/transfer device 100 are not particularly limited to these; however, a preparation from biological material (e.g., biont, body fluid, cell strain, tissue culture, or tissue fragment), a commercially available reagent, or the like can be exemplified. For example, polypeptides or polynucleotides can be exemplified.

The transfer membrane 1 is used in a state immersed in the buffer solution within the anode buffer tank 30.

In the first embodiment, the transfer membrane 1 is adequate so long as having a length used in one-time electrophoresis/transfer, i.e. length of a distance moved within the anode buffer tank 30 in the one-time electrophoresis/transfer. By configuring the transfer membrane 1 in this way, an operation to cut the transfer membrane 1 for every one-time electrophoresis/transfer becomes unnecessary, and thus the usability of the sample separation/transfer device 100 can be improved. In addition, the width of the transfer membrane 1 is sufficient so long as established as a length corresponding to the width of the separation gel 52.

(Frame)

In the first embodiment, the transfer membrane 1 is used in a state retained by the frame 20. In one example, the frame 20 consists of a frame lower part 20a and frame upper part 20b, and retains the transfer membrane 1 by sandwiching between the frame lower part 20a and frame upper part 20b, at both ends in the movement direction of the transfer membrane 1. The frame 20 is not limited thereto; however, for example, it is possible to constitute from synthetic resins such as Teflon (registered trademark), acrylic resin and PEEK resin.

However, the present invention is not limited thereto, and so long as the transfer membrane 1 is fixed, it is not a problem even if another configuration (for example, configuration detachably retaining the transfer membrane 1 by restraining with a retaining member, etc.).

(Arm Part)

In the first embodiment, the frame 20 is built into the arm part. The arm part causes the transfer membrane 1 to move and abut the first opening 50a. In the first embodiment, the arm part is configured from the frame 20, carrier 23 and guide poles 66, which are a series of connected members.

The guide pole 66 is a shaft member that is arranged so as to connect to a drive unit described later (shaft holder 65), and pass to outside of a side wall of the anode buffer tank 30. The carrier 23 is a member that connects to the guide poles 66, and connects to the frame 20 by going around the upper ends of the side walls of the anode buffer tank 30.

In the above way, the arm part passes along the outer sides of the side walls of the anode buffer tank 30 from a position connecting to the drive unit, goes around the upper ends of the side walls, and links at the inner sides of the side walls.

It should be noted that, although not to limit the present invention, in the first embodiment, the guide poles 66 extend at outer sides of the side walls of the anode buffer tank 30 until positions aligning with the upper ends of the side walls. Then, the carrier 23 fits together with the guide poles 66, and extends to an inner side of the side walls by spanning over the upper ends of the side walls of the anode buffer tank 30.

By configuring in this way, the carrier 23 can attach and detach easily to the drive unit. The guide poles 66 are arranged at the outer side of the side walls of the anode buffer tank 30, and do not become obstructions to various operations such as detachment of the anode buffer tank 30, or setting of electrodes, which are performed as necessary. For this reason, it is possible to successfully perform various operations by removing the carrier 23 as appropriate.

(Drive Unit)

The drive unit drives the arm part in a horizontal direction, and is configured by the motor 62, ball screw 63, guide shaft 64 and shaft holder 65 in the first embodiment.

The motor 62 causes the ball screw 63 to rotate. The motor 62 may employ one that can vary rotation speed, and may employ one of fixed rotation speed in combination with gears. The ball screw 63 threads with the shaft holder 65 along with penetrating the shaft holder 65. The guide shaft 64 penetrates the shaft holder 65, and the shaft holder 65 is configured to be movable along the guide shaft 64. Then, by the motor 62 causing the ball screw 63 to rotate, the shaft holder 65 is driven in the X-axis direction in the drawing (substantially horizontal direction). The shaft holder 65 connects with the arm part (guide pole 66), whereby the drive unit can drive the arm part in the X-axis direction in the drawing (substantially horizontal direction). Then, due to the arm part retaining the transfer membrane 1, the transfer membrane 1 moves in the X-axis direction in the drawing (substantially horizontal direction).

However, the present invention is not limited thereto, and so long as being able to drive the arm part in a substantially horizontal direction, the drive unit may be configured by another drive mechanism (e.g., belt, gears, etc.).

In addition, the drive unit is provided below the anode buffer tank 30. It is thereby possible to prevent the risk of the buffer solution scattered from the anode buffer tank 30 from causing the durability of the drive unit to decline, and the risk of the drive unit becoming a hindrance to various operations on the sample separation/transfer device 100.

(Tank)

Tanks 12a to 12e are vessels for storing the reagent or washing buffer required in the post-transfer processing. The tank 12f is a vessel for storing waste liquid. For example, washing buffer (e.g., PBS buffer, TBS buffer containing surfactant) can be filled in the tank 12a, blocking solution (e.g., BSA solution, casein solution, skim milk solution, polymer blocking liquid) in the tank 12b, primary antibody solution (e.g., antibody solution recognizing target protein, peptide aptamer solution, nucleic-acid aptamer solution, protein solution having interaction) in the tank 12c, secondary antibody solution (e.g., antibody solution recognizing primary antibody that is recognized by chromogenic substance, fluorescent substance, radioisotope or the like) in the tank 12d, and detection reaction solution (e.g., coloring or fluorescent solution such as horseradish peroxidase and alkaline phosphatase, etc.) in the tank 12e.

The tanks 12a to 12f are preferably made removable. So long as being removable, since it is possible to remove after use and easily wash inside the tank, contamination of reagent during the next use can be prevented.

It should be noted that the number of tanks in the present invention is not limited thereto, and a greater number of tanks may be provided, or a smaller number of tanks may be provided.

(Pump and Tube)

The pump 11a is connected to each of the tanks 12a, 12b, 12c, 12d and 12e via the tubes 13c, 13d, 13e, 13f and 13g, and is connected to the nozzle 14a via the tube 13a. The pump 11a can inject the liquid filling the tanks 12a, 12b, 12c, 12d and 12e arbitrarily into the anode buffer tank 30.

The pump 11b is connected to the tank 12f via the tube 13h, and is connected to the nozzle 14b via the tube 13b. The pump 11b can discharge the liquid inside of the anode buffer tank 30 to the tank 12f.

The pumps 11a, 11b are not particularly limited, and it is possible to use well-known pumps that are automatically controllable such as partition panel pumps, etc.

The tubes 13a to 13h are not particularly limited; however, they are preferably tubes of a soft material such as silicone tubes. In addition, the tubes 13a to 13h may be detachable from the tanks 12a to 12f, pumps 11a, 11b, as well as nozzles 14a, 14b. So long as being detachable configurations, it is possible to replace with new tubes in the case of the tube deteriorating, case of a clog arising, or the like.

(Control Unit)

The control unit 68 is a control panel for performing various controls on the sample separation/transfer device 100 (control of the position of arm part, control of current/voltage applied to anode 32 and cathode 41, control of pumps 113a, 11b, control of Peltier element 34, control of operation of partition panel 33, etc.). The control unit 68 may includes buttons and switches for receiving input from the user, and lamps, a display unit, etc. for notifying the operation state to the user.

(Electrophoresis of Sample, Transfer and Post-transfer Processing)

Next, the flow of electrophoresis of sample, transfer, and post-transfer processing in the sample separation/transfer device 100 of the first embodiment will be explained by referencing FIGS. 1 to 4. As shown in FIG. 1, during electrophoresis and transfer of sample, the transfer membrane 1 is retained in a state arranged at a position abutting the first opening 50a by the frame 20.

Buffer solution is filled into the anode buffer tank 30 and cathode buffer tank 40. In the first embodiment, for example, 400 mL of buffer solution is filled into the anode buffer tank 30, and 170 mL of buffer solution is filled into the cathode buffer tank 40.

Then, the sample is introduced to the separation gel 52 from the second opening 50b of the separation unit 50. In addition to biomolecules serving as the analysis target, it is preferable to add a visible molecular weight marker for confirming the progress of electrophoresis to the sample.

In the above state, separation is performed by electrophoresis of the sample. The control unit 68 controls the motor 62 to set the position of the transfer membrane 1 at the start position, and then flows electric current between the anode 32 and cathode 41 to start electrophoresis. The electric current value flowing between the anode 32 and cathode 41 is not particularly limited; however, it is preferably no more than 50 mA, and more preferably at least 20 mA to no more than 30 mA. It should be noted that it may control so that the electric current value becomes constant, may be controlled so that the voltage becomes constant, or the current and voltage may be controlled in other modes. The control unit 68 controls the Peltier element 34 to cool the anode buffer tank 30. The entirety of the sample separation/transfer device 100 is thereby cooled, whereby it is possible to prevent the smiling phenomenon in electrophoresis.

The transfer membrane 1 is moved gradually in the X axis towards the arrow direction in FIG. 1 by driving of the arm part by the drive unit, according to the progress of electrophoresis in the separation unit 50. The X-axis direction is a direction orthogonal to the longitudinal direction of the first opening 50a. Although the movement speed of the transfer membrane 1 is not particularly limited, it is possible to set a pace of moving 5 to 10 cm in 60 to 120 minutes, for example.

Then, the sample dispensed according to electrophoresis from the first opening 50a (sample separated in separation gel 52) is adsorbed at positions (positions opposing the first opening 50a at the dispensed timing) according to the timing of dispensing on the transfer membrane 1. The separated sample is thereby transferred to the transfer membrane 1.

After transfer, the arm part moves the transfer membrane 1 retained by the frame 20 until a position fitting in the second region 36. At this time, the arm part may cause the frame 20 to go up or down so that the frame 20 and separation unit 50 do not interfere.

Next, post-transfer processing is performed. In the first embodiment, the transfer membrane 1 is immunostained by Western blotting. In the first embodiment, for example, washing buffer is filled into the tank 12a, blocking solution into the tank 12b, primary antibody solution into the tank 12c, secondary antibody solution into the tank 12d, and detection reaction solution into the tank 12e, in advance.

First, the control unit 68 controls the pump 11b to discharge the buffer solution in the anode buffer tank 30 into the tank 12f. More specifically, the buffer solution in the anode buffer tank 30 moves to the tank 12f from the opening part 15b of the nozzle 14b, through the nozzle 14b, tube 13b, pump 11b and tube 13h, in order. Next, the partition panel projects from the bottom face of the anode buffer tank 30 according to the control of the control unit 68, and divides the anode buffer tank 30 into the first region 35 and second region 36.

Next, the pump 11a is controlled to inject the washing buffer in the tank 12a into the anode buffer tank 30. More specifically, the washing buffer in the tank 12a moves from the opening part 15a of the nozzle 14a into the anode buffer tank 30 through the tube 13c, pump 11a, tube 13a and nozzle 14a, in order. The amount of washing buffer is 100 mL, for example. Washing is performed for 5 min, for example. At this time, it is preferable for the control unit 68 to control the arm part, causing the transfer membrane 1 to move back and forth in the X axis direction to perform shaking. It is thereby possible to perform washing efficiently, and possible to realize shortening of time and an improvement in sensitivity. Subsequently, the pump 11b is controlled to discharge the solution in the anode buffer tank 30 into the tank 12f. Washing is performed three times, for example.

After washing, the control unit 68 controls the pump 11a to inject the blocking solution in the tank 12b into the anode buffer tank 30. More specifically, the blocking solution in the tank 12b moves from the opening part 15a of the nozzle 14a into the anode buffer tank 30, through the tube 13d, pump 11a, tube 13a and nozzle 14a, in order. The liquid amount of the blocking solution is 100 mL, for example. It is thereby possible to perform blocking. The blocking is performed over 1 hour, for example. At this time, it is preferable for the control unit 68 to control the arm part, causing the transfer membrane 1 to go back and forth in the X axis direction, to perform shaking. It is thereby possible to efficiently perform blocking, and possible to realize shortening of time and an improvement in sensitivity.

After blocking completion, the control unit 68 controls the pump 11b to discharge the blocking solution in the anode buffer tank 30 into the tank 12f. Next, the control unit 68 controls the pump ha to inject the primary antibody solution in the tank 12c into the anode buffer tank 30. More specifically, the primary antibody solution in the tank 12c moves from the opening part 15a of the nozzle 14a into the anode buffer tank 30 through the tube 13e, pump 11a, tube 13a and nozzle 14a, in order. The amount of primary antibody solution is 10 mL, for example. The reaction is carried out over 1 hour, for example. At this time, it is preferable for the control unit 68 to control the arm part, causing the transfer membrane 1 to go back and forth in the X axis direction to perform shaking. The opportunities for contact between analyte and primary antibody thereby increase, and it is possible to realize shortening of time and an improvement in sensitivity. In addition, the control unit 68 controls the Peltier element 34 to raise the temperature of the anode buffer tank 30 (e.g., 37° C.). The reaction with the primary antibody is thereby promoted, and it is possible to realize shortening of time and an improvement in sensitivity.

After reaction completion, the control unit 68 controls the pump ha to inject the washing buffer in the tank 12a into the anode buffer tank 30. The amount of washing buffer is 100 mL, for example. Washing is performed for 5 min, for example. At this time, it is preferable for the control unit 68 to control the arm part, causing the transfer membrane 1 to go back and forth in the X axis direction to perform shaking. Subsequently, the pump 11b is controlled to discharge the solution in the anode buffer tank 30 into the tank 12f. Washing is performed three times, for example.

After washing, the control unit 68 controls the pump ha to inject the secondary antibody solution in the tank 12d into the anode buffer tank 30. More specifically, the second antibody solution in the tank 12d moves from the opening part 15a of the nozzle 14a into the anode buffer tank 30, through the tube 13f, pump 11a, tube 13a and nozzle 14a, in order. The amount of secondary antibody solution is 10 mL, for example. The reaction is performed over 1 hour, for example. At this time, it is preferable for the control unit 68 to control the arm part, causing the transfer membrane 1 to go back and forth in the X axis direction to perform shaking. The opportunity for contact between the analyte and secondary antibody thereby increases, and it is possible to realize shortening of time and an improvement in sensitivity. The control unit 68 controls the Peltier element 34 to raise the temperature of the anode buffer tank 30 (e.g., 37° C.). The reaction with the secondary antibody is thereby promoted, and it is possible to realize shortening of time and an improvement in sensitivity.

After reaction completion, the control unit 68 controls the pump ha to inject the washing buffer in the tank 12a into the anode buffer tank 30. The amount of washing buffer is 100 mL, for example. Washing is performed for 5 min, for example. At this time, it is preferable for the control unit 68 to control the arm part, causing the transfer membrane 1 to go back and forth in the X axis direction to perform shaking. Subsequently, the pump 11b is controlled to discharge the solution in the anode buffer tank 30 into the tank 12f. Washing is performed three times, for example.

After washing, the control unit 68 controls the pump ha to inject the detection reaction solution in the tank 12e into the anode buffer tank 30. More specifically, the detection reaction solution in the tank 12e moves from the opening part 15a of the nozzle 14a into the anode buffer tank 30, through the tube 13g, pump 11a, tube 13a and nozzle 14a, in order. The amount of detection reaction solution is 10 mL, for example. The reaction is performed for 1 hour, for example.

After reaction completion, the control unit 68 controls the pump 11a to inject the washing buffer in the tank 12a into the anode buffer tank 30. The amount of washing buffer is 100 mL, for example. Washing is performed for 5 min, for example. At this time, it is preferable for the control unit 68 to control the arm part, causing the transfer membrane 1 to go back and forth in the X axis direction to perform shaking. Subsequently, the pump 11b is controlled to discharge the solution in the anode buffer tank 30 into the tank 12f. Washing is performed for three times, for example.

It should be noted that the sequence of immunostaining of the transfer membrane 1 is not limited to that described above, and it is possible to omit washing, or add washing as appropriate.

The transfer membrane 1 obtained in this way is recovered, and the separation pattern of components transferred to the transfer membrane 1 are detected by way of a fluorescence detector or the like. Such a fluorescence detector may be built into the sample separation/transfer device 100, and can thereby automate all steps of electrophoresis, transfer, post-transfer processing and detection.

### Second Embodiment

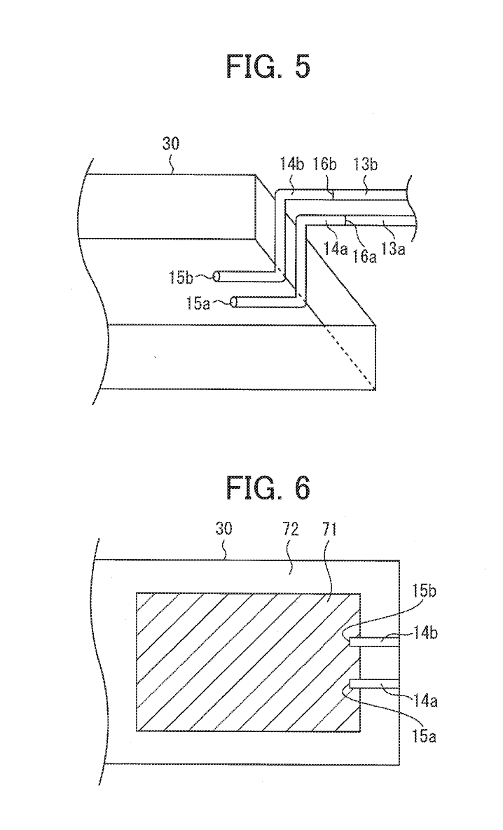

Another embodiment (second embodiment) of the present invention is as follows when explaining based on FIG. 5. It should be noted that, for convenience of explanation, members having the same function as members explained in the first embodiment are assigned the same reference numbers, and explanations thereof will be omitted.

The points of difference between the second embodiment and first embodiment are the shapes of the nozzles 14a, 14b, and the configurations of the bottom face of the anode buffer tank 30. Other points are the same as the first embodiment.

(Nozzle)

In the second embodiment, as shown in FIG. 5, the end of the nozzles 14a, 14b having the opening part 15a, 15b is folded in an L-shape along the side face and bottom face in the anode buffer tank 30, and the opening parts 15a, 15b open in a perpendicular direction relative to the bottom face of the anode buffer tank 30.

Recovery of the waste liquid (used liquid) in the anode buffer tank 30 from the nozzle 14b thereby becomes easier. In particular, although not illustrated in the drawings, it is possible to further facilitate the recovery of waste liquid by angling the bottom face of the anode buffer tank 30 to make the waste liquid flow to the nozzle 14b side.

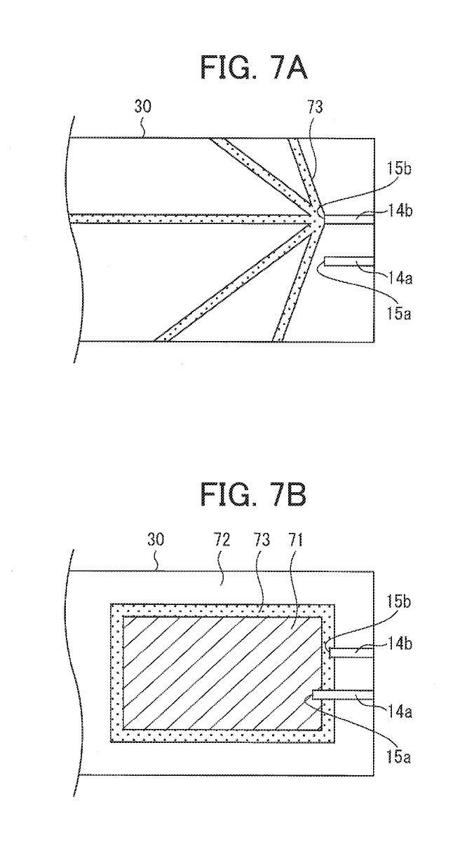

In addition, in a modified example, it may be configured to provide grooves 73 in the bottom face of the anode buffer tank 30 so that the waste liquid flows to the periphery of the nozzle 14b. The grooves 73 are preferably provided radially with the opening part 15b of the nozzle 14b as the origin, as shown in FIG. 7(a), for example. By making such a configuration, it is possible to cause the waste liquid to efficiently flow to the opening part 15b from the entirety of the bottom face of the anode buffer tank 30. For this reason, the waste liquid remaining in the anode buffer tank 30 can be decreased, and thus it is possible to realize an improvement in sensitivity. Furthermore, the nozzle 14b may be provided in the groove 73. It is thereby possible to further facilitate recovery of waste liquid. The groove 73 can be made with a depth of 0.1 mm to 1 mm, and width of 11 mm, for example.

(Electrophoresis of Sample, Transfer and Post-transfer Processing)

The flow of the electrophoresis of sample, transfer, and post-transfer processing in the sample separation/transfer device 100 of the second embodiment is the same as the first embodiment.

### Third Embodiment

Another embodiment (third embodiment) of the present invention is as follows when explaining based on FIG. 6. It should be noted that, for convenience of explanation, members having the same function as members explained in the first embodiment are assigned the same reference numbers, and explanations thereof will be omitted.

The points of difference between the third embodiment and first embodiment are the material and configuration of the bottom face of the anode buffer tank 30. Other points are the same as the first embodiment.

(Bottom Face of Anode Buffer Tank)

In the third embodiment, as shown in FIG. 6, a hydrophilic region (partial region) 71 and hydrophobic region (other region) 72 exist on the bottom face of the anode buffer tank 30. More specifically, the hydrophilic region 71 exists in the second region 36. In other words, the bottom face of the anode buffer tank 30 (specifically, second region 36) includes the hydrophilic region 71 and the hydrophobic region 72 arranged so as to surround this hydrophilic region 71.

The hydrophilic region 71 is configured by glass, a resin material that has been plasma treated, etc. The hydrophobic region 72 is configured by a resin material (acrylic, polycarbonate, polyvinyl chloride, polyethylene, polypropylene, polystyrene, acrylonitrile styrene, polyethylene, terephthalate, etc.), for example.

The hydrophilic region 71 exists at a position opposing with the position of the transfer membrane 1 upon performing the post-transfer processing. The size of the hydrophilic region 71 is preferably substantially equal to the transfer membrane 1. In addition, the opening parts 15a, 15b exist at positions contacting the hydrophilic region 71. According to this configuration, in the case of injecting a small amount of liquid from the opening part 15a, it is possible to efficiently retain this liquid in the hydrophilic region 71. For this reason, the amount of expensive reagent (antibody solution, etc.) used can be decreased. In addition, it is possible to cause even, uniform reaction. In the third embodiment, for example, the used amount of primary antibody solution, secondary antibody solution and detection reaction solution can be set to no more than 10 mL, preferably no more than 5 mL, and even more preferably no more than 3 mL.

In the third embodiment, it is possible to automatically perform, inside the anode buffer tank 30, both steps using a solution for which the amount used one time is preferably great as in the buffer solution for electrophoresis, washing buffer and blocking solution, and steps using a liquid for which the amount used one time is preferably small as in the antibody solutions and the detection reaction solution, in more preferred liquid amounts, respectively.

In addition, in the modified example, it may be configured to provide the groove 73 in the bottom face of the anode buffer tank 30, so that the waste liquid flows to the periphery of the nozzle 14b. The groove 73 is preferably provided at the boundary between the hydrophilic region 71 and the hydrophobic region 72, as shown in FIG. 7(b), for example. More specifically, it is provided so as to surround the hydrophilic region 71. At this time, the groove 73 is preferably hydrophilic. By making such a configuration, it is possible to make the liquid retained in the hydrophilic region 71 to effectively flow into the opening part 15b. For this reason, it is possible to decrease the waste liquid remaining in the anode buffer tank 30, and it is possible to realize an improvement in sensitivity. Furthermore, the nozzle 14b may be provided in the groove 73. It is thereby possible to further facilitate the recovery of waste liquid. The groove 73 can be made with a depth of 0.1 mm to 1 mm, and width of 11 mm, for example.

(Electrophoresis of Sample, Transfer and Post-transfer Processing)

The flow of the electrophoresis of sample, transfer, and post-transfer processing in the sample separation/transfer device 100 of the third embodiment is the same as the first embodiment. In addition, the nozzles of the sample separation/transfer device 100 of the third embodiment are explained as being the same as the second embodiment; however, they may be the same as the first embodiment.

### Fourth Embodiment

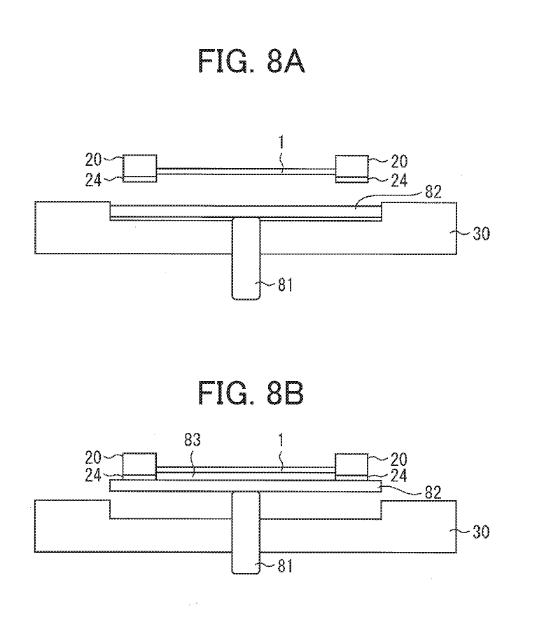

Another embodiment (fourth embodiment) of the present invention is as follows when explaining based on FIG. 8. It should be noted that, for convenience of explanation, members having the same function as members explained in the first to third embodiments are assigned the same reference numbers, and explanations thereof will be omitted.

The points of difference between the fourth embodiment and third embodiment are the structure of the bottom face of the anode buffer tank 30, and the positions of the opening parts 15a, 15b. The other points are the same as the third embodiment.

(Lift Plate)

In the fourth embodiment, a lift plate 82 that is made so as to move in a direction to disjoin relative to the transfer membrane 1, as shown in FIG. 8, is equipped to the bottom face of the anode buffer tank 30. In other words, the lift plate 82 is equipped at a position corresponding to the hydrophilic region 71 in the second embodiment. Herein, the size of the lift plate 82 is larger than the transfer membrane 1. In other words, the size of the lift plate 82 is larger than the inside diameter of the frame 20. For this reason, when the lift plate 82 moves in a direction approaching the transfer membrane 1, the lift plate 82 abuts the frame 20, and a space 83 sealed by the lift plate 82, frame 20 and transfer membrane 1 is formed. In a state placing the liquid injected to the anode buffer tank 30 on the lift plate 82, it is possible to retain this liquid in the space 83 so long as moving in a direction approaching the transfer membrane 1. In this case, since the distance from the transfer membrane 1 is short compared to a case of not having the lift plate 82, it is possible to cause this liquid to contact the transfer membrane 1 even with a small liquid amount. For this reason, it is possible to further decrease the amount used of expensive reagent (antibody solutions, etc.). In addition, it is possible to cause even, uniform reaction. In the fourth embodiment, for example, the used amount of primary antibody solution, secondary antibody solution and detection reaction solution can be set to no more than 5 mL, preferably no more than 3 mL, and even more preferably no more than 1 mL.

In the fourth embodiment, the lift plate 82 lifts by way of a ball screw 81 provided at the bottom part. The ball screw 81 is controlled by the control unit 68. However, the present invention is not limited to the ball screw 81, and may be done by another method (for example, solenoid, etc.) that causes the lift plate 82 to lift.

The lift plate 82 preferably has outer edges on the upper face that are hydrophobic, and other regions that are hydrophilic. In this case, the lift plate 82 more preferably has a portion contacting the frame 20 and an outer side from this portion that are hydrophobic regions. If such a configuration, it is possible to more reliably retain liquid at the inner side on the upper face of the lift plate 82 (i.e. hydrophilic region).

In addition, as shown in FIG. 8, it is preferable for a gasket 24 to be provided at the bottom face of the frame 20.

If such a configuration, it is possible to prevent liquid retained in the space 83 from leaking through a gap between the lift plate 82 and frame 20. For this reason, it possible to more reliably retain liquid in the space 83.

(Nozzle)

The nozzles 14a, 14b of the fourth embodiment are equipped at positions not overlapping the lift plate 82. In other words, the opening parts 15a, 15b contact portions on the bottom face of the anode buffer tank 30 at which the lift plate 82 is not provided. The opening part 15a is more preferable at a closer position to the lift plate 82, due to liquid tending to be arranged on the hydrophilic region 71.

(Electrophoresis of Sample, Transfer and Post-transfer Processing)

The flow of the electrophoresis of sample, transfer and post-transfer processing in the sample separation/transfer device 100 of the fourth embodiment.

The electrophoresis of sample and transfer are the same as the first embodiment.

After transfer, the transfer membrane 1 is moved as is to a position to fit in the second region 36. More specifically, it is moved until a position opposing the lift plate 82. At this time, the lift plate 82 is in a state lowered to the height of the bottom face of the anode buffer tank 30 (FIG. 8(a)).

First, the control unit 68 controls the pump 11b to discharge the buffer solution in the anode buffer tank 30 into the tank 12f. Next, the partition panel 33 projects from the bottom face of the anode buffer tank 30 according to the control of the control unit 68, and divides the anode buffer tank 30 into the first region 35 and second region 36.

Next, similarly to the first embodiment, the control unit 68 controls the pump 11a to inject the washing buffer in the tank 12a into the anode buffer tank 30 to perform washing. Subsequently, the pump 11b is controlled to discharge the solution inside the anode buffer tank 30 into the tank 12f. Washing is performed three times, for example.

Next, the control unit 68 controls the pump 11a to inject the blocking solution in the tank 12b into the anode buffer tank 30 to perform blotting. After blocking completion, similarly to the first embodiment, the control unit 68 controls the pump 11b to discharge the solution in the anode buffer tank 30 into the tank 12f.

Next, the control unit 68 controls the pump 11a to inject the primary antibody solution in the tank 12c into the anode buffer tank 30. The amount of primary antibody solution is 1 mL, for example. At this time, the upper face of the lift plate 82 enters a state with the primary antibody solution placed thereon. Next, the control unit 68 controls the ball screw 81 to gradually raise the lift plate 82 until contacting the frame 20 (more accurately, the gasket 24) (FIG. 8(b)). The reaction between analyte and primary antibody is thereby performed. Herein, the analyte exists on the upper face side of the transfer membrane 1; whereas, the primary antibody solution exists on the bottom face side of the transfer membrane 1; however, the transfer membrane 1 enables reaction also from the bottom face side. The reaction is performed over 1 hour, for example.

After reaction completion, the control unit 68 controls the ball screw 81 to lower the lift plate 82 to the height of the bottom face of the anode buffer tank 30. Next, the control unit 68 controls the pump 11a to inject the washing buffer in the tank 12a into the anode buffer tank 30. The amount of washing buffer is 100 mL, for example. Washing is performed similarly to the first embodiment, the control unit 68 controls the pump 11b to discharge the solution in the anode buffer tank 30 into the tank 12f.

After washing, the control unit 68 controls the pump 11a to inject the secondary antibody solution in the tank 12d into the anode buffer tank 30. The amount of secondary antibody solution is 1 mL, for example. At this time, the upper face of the lift plate 82 enters a state with the secondary antibody solution placed thereon. Next, the control unit 68 controls the ball screw 81 to gradually raise the lift plate 82 until contacting the frame 20 (more accurately, the gasket 24). The reaction between analyte and secondary antibody is thereby performed.

After reaction completion, the control unit 68 controls the ball screw 81 to lower the lift plate 82 to the height of the bottom face of the anode buffer tank 30. Next, the control unit 68 controls the pump 11a to inject the washing buffer in the tank 12a into the anode buffer tank 30. The amount of washing buffer is 100 mL, for example. Washing is performed similarly to the first embodiment, and the control unit 68 controls the pump 11b to discharge the solution in the anode buffer tank 30 into the tank 12f.

After washing, the control unit 68 controls the pump ha to inject the detection reaction solution in the tank 12e into the anode buffer tank 30. The amount of detection reaction solution is 1 mL, for example. At this time, the upper face of the lift plate 82 enters a state with the detection reaction solution placed thereon. Next, the control unit 68 controls the ball screw 81 to gradually raise the lift plate 82 until contacting the frame 20 (more accurately, the gasket 24). Reaction with the detection reaction solution is thereby performed.

After reaction completion, the control unit 68 controls the ball screw 81 to lower the lift plate 82 to the height of the bottom face of the anode buffer tank 30. Next, the control unit 68 controls the pump ha to inject the washing buffer in the tank 12a into the anode buffer tank 30. The amount of washing buffer is 100 mL, for example. Washing is performed similarly to the first embodiment, the control unit 68 controls the pump 11b to discharge the solution in the anode buffer tank 30 into the tank 12f.

It should be noted that the sequence of immunostaining of the transfer membrane 1 is not limited to that described above, and it is possible to omit washing, or add washing as appropriate.

The transfer membrane 1 obtained in this way is recovered, and the separation pattern of components transferred to the transfer membrane 1 are detected by way of a fluorescence detector or the like. Such a fluorescence detector may be built into the sample separation/transfer device 100, and can thereby automate all steps of electrophoresis, transfer, post-transfer processing and detection.

In the fourth embodiment, it is possible to automatically perform, inside the anode buffer tank 30, both steps using a solution for which the amount used one time is preferably great as in the buffer solution for electrophoresis, washing buffer and blocking solution, and steps using a liquid for which the amount used one time is preferably small as in the antibody solutions and the detection reaction solution, in more preferable liquid amounts, respectively.

### Fifth Embodiment

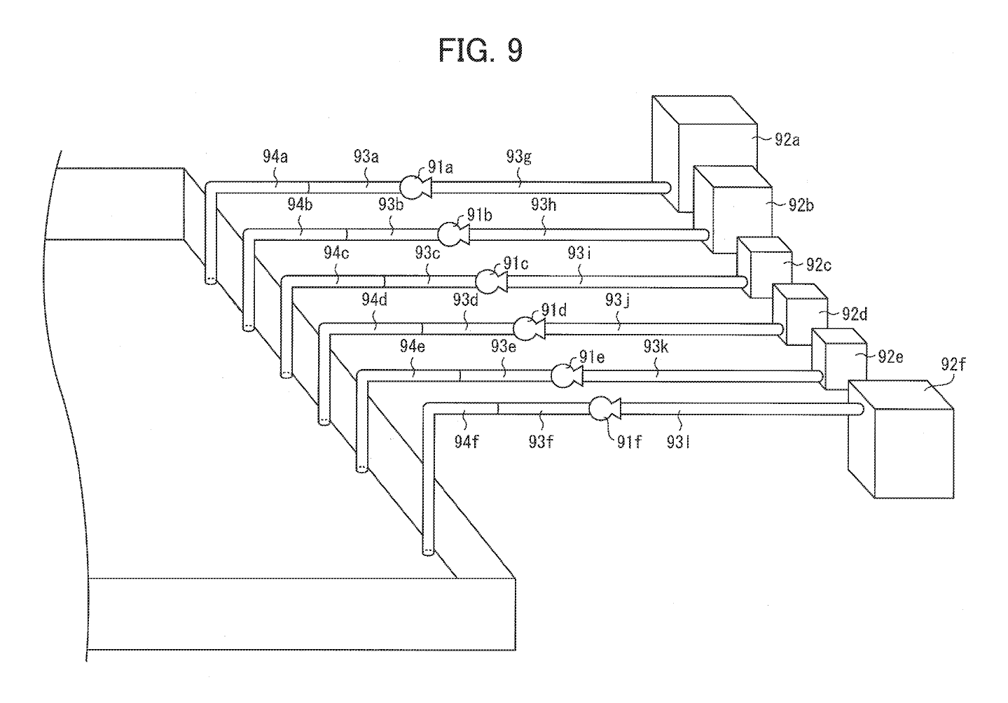

Another embodiment (fifth embodiment) of the present invention is as follows when explaining based on FIG. 9. It should be noted that, for convenience of explanation, members having the same function as members explained in the first embodiment are assigned the same reference numbers, and explanations thereof will be omitted.

The points of difference between the fifth embodiment and first embodiment are the connection methods of the tank, tube, pump and nozzle for injection. Other points are the same as the first embodiment.

(Tank, Tube, Pump and Nozzle)

In the fifth embodiment, tanks 92a to 92f corresponding to the tanks 12a to 12f of the first embodiment are provided. Herein, as shown in FIG. 9, nozzles 94a to 94f are equipped at the inside face of the second region 36, inside the anode buffer tank 30. The tanks 92a to 92f are connected to the nozzles 94a to 94f via the tubes 93g to 93l, pumps 91a to 91f, and tubes 93a to 93f. In other words, the tanks 92a to 92f individually include tubes, pumps and nozzles. In this way, in the fifth embodiment, the tanks for injection (tanks 92a to 92e) individually include tubes, pumps and nozzles. With such a configuration, since each liquid is injected into the anode buffer tank 30 by separate routes, there is an advantage in that the risk of contamination of reagent is small.

It should be noted that the position and orientation of the opening part of the nozzle is not limited to those shown in FIG. 9, and may be the same as the second embodiment, or may be another form.

(Modified Example)

In the sample separation/transfer devices 100 of the first and fifth embodiments, similarly to the second embodiment, the hydrophilic region 71 and hydrophobic region 72 may exist at the bottom face of the anode buffer tank 30.

In addition, in the sample separation/transfer devices 100 of the first and fifth embodiments, similarly to the third embodiment, the lift plate 82 may be equipped at the bottom face of the anode buffer tank 30.

In addition, in the sample separation/transfer devices 100 of the first to fifth embodiments, the bottom face of the anode buffer tank 30 may be sloped. A portion at which the opening of the nozzle 14b or 94f is positioned is preferably lower. If such a configuration, it is possible to collect the liquid at a low portion upon discharging this liquid from the anode buffer tank 30. For this reason, recovery of liquid becomes easy.

In addition, in the sample separation/transfer devices 100 of the first to fifth embodiments, the tanks 12b to 12e or 92b to 92e may not be included. In this case, it is possible to establish a device that places the washing buffer in the tank 12a or 92a, and performs up to the step of washing after transfer.

In addition, in the sample separation/transfer devices 100 of the first to fifth embodiments, the tanks 12c to 12e or 92c to 92e may not be included. In this case, it is possible to establish a device that places the washing buffer in the tank 12a or 92a, places the blocking solution in the tank 12b or 92b, and performs up to the washing after transfer and blocking steps.

In addition, in the sample separation/transfer devices 100 of the first to fifth embodiments, the tanks 12d to 12e or 92d to 92e may not be included. In this case, it is possible to establish a device that places the washing buffer in the tank 12a or 92a, places the blocking solution in the tank 12b or 92b, places the primary antibody solution in the tank 12cor 92c, and performs up to the post-transfer washing, blocking and primary antibody reaction steps.

In addition, in the sample separation/transfer devices 100 of the first to fifth embodiments, the tank 12e or 92e may not be included. In this case, it is possible to establish a devices that places the washing buffer in the tank 12a or 92a, places the blocking solution in the tank 12b or 92b, places the primary antibody solution in the tank 12c or 92c, places the secondary antibody solution in the tank 12d or 92d, and performs up to the post-transfer washing, blocking, primary antibody reaction and secondary antibody reaction steps.

In addition, in the sample separation/transfer device 100 of the first to fifth embodiments, the tanks may not be established as constituent elements. In this case, during use of the sample separation/transfer device 100, the user may prepare a tank and connect with a tube.

In addition, in the sample separation/transfer devices 100 of the first to fifth embodiments, the post-transfer processing is not limited to immunostaining using antibody, and may be processing according to another method capable of detecting proteins or peptides. In addition, in the case of the sample not being proteins or peptides, processing can be performed by a method suited to the sample.

(Summary)

A sample separation/transfer device 100 according to a first aspect of the present invention separates analyte by way of electrophoresis, dispenses the analyte thus separated from a dispensing part (first opening 50a) in a buffer tank (anode buffer tank 30), and transfers the analyte thus separated onto a transfer membrane 1 by causing the transfer membrane 1 to abut the dispensing part and move, the device including a liquid delivery pump (pumps 11a, 11b or 91a to 91f) that replaces liquid filling the buffer tank.

According to the above-mentioned configuration, it is possible to replace the liquid filling the buffer tank by way of the liquid delivery pump. It is thereby possible to automatically perform the step of separating analyte by way of electrophoresis, the step of transferring analyte to the transfer membrane and post-transfer processing (washing, blocking, antibody reaction, detection reaction, etc.) steps. For this reason, it is possible to simply perform Western blotting.

According to a second aspect of the present invention, in the sample separation/transfer device according of the first aspect, the liquid delivery pump may perform replacement of the liquid filling the buffer tank between two liquids selected from the group consisting of anode buffer, washing liquid, blocking solution, antibody solution and detection reaction solution.

According to the above-mentioned configuration, it is possible to simply perform Western blotting.

According to a third aspect of the present invention, in the sample separation/transfer device of the first or second aspect, a bottom face of the buffer tank may have a partial region that is hydrophilic, and a region surrounding the partial region that is hydrophobic.

According to the above-mentioned configuration, in the case of filling the buffer tank with a small amount of liquid, it is possible to efficiently retain this liquid in the hydrophilic region. So long as the transfer membrane 1 is made to contact the liquid retained in the hydrophilic region, it is possible to efficiently promote the reaction. For this reason, it is possible to decrease the liquid amount of expensive reagent.

According to a fourth aspect of the present invention, in the sample separation/transfer device of the first or second aspect, a bottom face of the buffer tank may include a lift plate (lift plate 82) that moves in a direction disjoining relative to the transfer membrane.

According to the above-mentioned configuration, the distance between a part of the bottom face of the buffer tank (i.e. lift plate) and the transfer membrane 1 becomes shorter. For this reason, by moving in a direction approaching the transfer membrane 1 in a state retaining the liquid on the lift plate, it is possible to cause the liquid to contact the transfer membrane 1, even if a small liquid amount. For this reason, it is possible to further decrease the liquid amount of expensive reagent, and possible to promote the reaction efficiently.

According to a fifth aspect of the present invention, in the sample separation/transfer device of the fourth aspect, an upper face of the lift plate may have an outer edge part that is hydrophobic, and other regions thereof may be hydrophilic.

According to the above-mentioned configuration, it is possible to more reliably retain the liquid at the inner side (i.e. hydrophilic region) on the upper face of the lift plate.

According to a sixth aspect of the present invention, the sample separation/transfer device of the first to fifth aspects may further include a partition panel that is housed in the bottom face of the buffer tank, and can divide the buffer tank into two regions (first region 35 and second region 36) by projecting.

According to the above-mentioned configuration, the buffer tank is divided into two regions by the partition panel 33. By performing electrophoresis and post-transfer operations only in one region, it is possible to decrease the liquid amount used. For this reason, it is possible to achieve savings in expensive reagent and shortening in time.

According to a seventh aspect of the present invention, in the sample separation/transfer device of the first to sixth aspects, the bottom face of the buffer tank may be sloped.

According to the above-mentioned configuration, it is possible to collect the liquid filling the buffer tank at a low region of the buffer tank during the replacement of liquid. For this reason, it is possible to efficiently perform replacement of the liquid filling the buffer tank.

According to an eighth aspect of the present invention, in the sample separation/transfer device of the first to seventh aspects, a groove (groove 73) may be provided in the bottom face of the buffer tank.

According to the above-mentioned configuration, it is possible to collect the liquid filling the buffer tank at the groove in the bottom face of the buffer tank, during replacement of liquid. For this reason, it is possible to efficiently perform replacement of the liquid filling the buffer tank.

According to a ninth aspect of the present invention, the sample separation/transfer device of the first to eighth aspects may further include an arm part that retains and shakes the transfer membrane.

According to the above-mentioned configuration, it is possible to retain the transfer membrane 1 by the arm and shake in post-transfer processing. For this reason, it is possible to efficiently perform reaction.

A sample analysis method according to a tenth aspect of the present invention performs separation of analyte, transfer to a transfer membrane and immunostaining (e.g., washing, blocking, antibody reaction, detection reaction, etc.) using the sample separation/transfer device according to any one of the first to ninth aspects, the method including performing transfer to the transfer membrane 1 and immunostaining inside a buffer tank.

According to the above-mentioned configuration, similar effects as the above-mentioned first to ninth aspects are exerted.

The present invention is not to be limited the aforementioned embodiment, with various modifications being possible within the scope indicated by the claims, and embodiments obtained by appropriately combining the technical means disclosed in each of the different embodiments are also included in the technical scope of the present invention. Furthermore, it is possible to form novel technical features by combining the technical means disclosed in each of the respective embodiments.

### INDUSTRIAL APPLICABILITY

The present invention is applicable to analysis fields of biomolecules, etc.

### EXPLANATION OF REFERENCE NUMERALS

1 transfer membrane

11a, 11b pump (liquid delivery pump)

12a to 12f tank

13a to 13h tube

14a, 14b nozzle

15a, 15b opening part

16a, 16b connection

20 frame

20a frame lower part

20b frame upper part

23 carrier (arm part)

24 gasket

30 anode buffer tank (buffer tank)

31 table

32 anode

33 partition panel

34 Peltier element

35 first region

36 second region

40 cathode buffer tank

41 cathode

42 lock

50 separation unit

50a first opening (dispensing part)

50b second opening

51, 53 insulating plate

52 separation gel (separation medium)

62 motor (drive unit)

63 ball screw (drive unit)

64 guide shaft (drive unit)

65 shaft holder (drive unit)

66 guide pole (arm part)

68 control unit

71 hydrophilic region (partial region)

72 hydrophobic region (region surrounding partial region)

73 groove

81 ball screw

82 lift plate

83 space

91a to 91f pump (liquid delivery pump)

92a to 92f tank

93a to 93l tube

94a to 94f nozzle

100 separation/transfer device

1. A sample separation/transfer device that separates analyte by way of electrophoresis, dispenses the analyte thus separated from a dispensing part in a buffer tank, and transfers the analyte thus separated onto a transfer membrane by causing the transfer membrane to abut the dispensing part and move,
the device comprising a liquid delivery pump that replaces liquid filling the buffer tank.

2. The sample separation/transfer device according to claim 1, wherein the liquid delivery pump performs replacement of the liquid filling the buffer tank between two liquids selected from the group consisting of anode buffer, washing liquid, blocking solution, antibody solution and detection reaction solution.

3. The sample separation/transfer device according to claim 1, wherein a bottom face of the buffer tank has a partial region that is hydrophilic, and a region surrounding the partial region that is hydrophobic.

4. The sample separation/transfer device according to claim 1, wherein a bottom face of the buffer tank includes a lift plate that moves in a direction disjoining relative to the transfer membrane.

5. The sample separation/transfer device according to claim 4, wherein an upper face of the lift plate has an outer edge part that is hydrophobic, and other regions thereof are hydrophilic.

6. The sample separation/transfer device according to claim 1, further comprising a partition panel that is housed in the bottom face of the buffer tank, and can divide the buffer tank into two regions by projecting.

7. The sample separation/transfer device according to claim 1, wherein the bottom face of the buffer tank is sloped.

8. The sample separation/transfer device according to claim 1, wherein a groove is provided in the bottom face of the buffer tank.

9. The sample separation/transfer device according to claim 1, further comprising an arm part that retains and shakes the transfer membrane.

10. A sample analysis method of performing separation of analyte, transfer to a transfer membrane and immunostaining using the sample separation/transfer device according to claim 1, the method comprising performing transfer to the transfer membrane and immunostaining inside a buffer tank.
